(19) United States
(12) Patent Application Publication
(10) Pub. No.: US 2011/0062079 A1
(43) Pub. Date: Mar. 17, 2011

(54) PROCESS FOR TREATING WATER BY A NANOFILTRATION OR REVERSE OSMOSIS MEMBRANE SYSTEM ENABLING HIGH CONVERSION RATES DUE TO THE ELIMINATION OF ORGANIC MATTER

(75) Inventors: Catherine Daines-Martinez, Andressy (FR); Jean-Christophe Schrotter, Maisons Laffitte (FR); Philippe Breant, Neauphle le Chateau (FR)

(73) Assignee: VEOLIA WATER SOLUTIONS & TECHNOLOGIES SUPPORT, Saint-Maurice Cedex (FR)

(21) Appl. No.: 12/867,588

(22) PCT Filed: Feb. 12, 2009
(86) PCT No.: PCT/EP09/51669

§ 371 Date: Dec. 2, 2010

(30) Foreign Application Priority Data
Feb. 14, 2008 (FR) 0850947

(51) Int. Cl. C02F 9/02; C02F 1/44; C02F 3/00

(52) U.S. Cl. 210/601; 210/638

(57) ABSTRACT

The invention relates to a process for treating freshwater, sea water, brackish water or water exiting a drinking water treatment plant containing organic matter, with a view to the potabilization thereof, recycling thereof, desalination thereof, or with a view to the purification thereof for an industrial application, said process comprising at least a first step (11) of filtration, by a nanofiltration or reverse osmosis, of a flow coming in from a primary treatment step (10) and a second step (13) of filtration, by nanofiltration or reverse osmosis, of a concentrate coming from said first filtration step (11). According to the invention, such a process comprises a step (12, 12′) of intermediate treatment that includes a biological and/or oxidation treatment and/or a coagulation at low pH of said concentrate coming from said first filtration step (11) and/or of said concentrate coming from said second filtration step (13).

### FIELD OF THE INVENTION

The field of the invention is that of water treatment.

More specifically, the invention relates to the treatment of freshwater, brackish water, seawater, or water leaving a wastewater treatment plant, for the potabilization, desalination or recycling thereof or for the purification thereof by implementing membrane processes, in particular nanofiltration or reverse osmosis.

### PRIOR ART AND DISADVANTAGE OF THE PRIOR ART

Membrane filtration processes are commonly implemented in order to render potable, recycle, desalinate or purify water in order to confer a quality thereon capable of making it suitable for use in various industrial processes.

The membrane processes conventionally used (ultrafiltration, microfiltration and more recently nanofiltration and reverse osmosis) involve passing the water to be treated (also called raw water) through membranes that physically retain the elements initially present in the water.

The size of the elements that can be retained by a membrane reflect the cutoff thereof. Thus, microfiltration membranes have a cutoff on the order of 0.1 μm, ultrafiltration membranes have a cutoff on the order of 0.01 μm and nanofiltration membranes have a cutoff on the nanometric scale.

It has thus been proposed to render potable, purify, recycle or desalinate water by subjecting it to a filtration step by causing it, for example, to pass through a nanofiltration membrane filtration unit or a reverse osmosis unit. It is noted that the nanofiltration or the reverse osmosis are generally preceded, so as to limit the clogging of the membranes used, by a pretreatment that can consist in particular of grit removal, coagulation, flocculation and settling so as to remove a large proportion of the particles, in particular colloidal particles, initially in suspension.

This type of treatment process enables between 40% and 90%, and, more generally for nanofiltration, between 75% and 85% of treated water to be produced, which corresponds to the permeates from the membranes, and, in return, generates at best between 15% to 25% residues called concentrates.

These concentrates, which may be high in salt, organic matter and pesticides retained by the membranes, are generally discharged into the natural environment.

Generally, the environmental impact of nanofiltration or reverse osmosis concentrates on the receiving environment is minor. However, to avoid returning pollutants already present in the collected surface water to the natural water, and in order to preserve the quality of our environment, it is necessary to limit the volume of these residues and, if necessary, to remove the pollutants or micropollutants therefrom.

In other words, there is a considerable need for processes for treating water by nanofiltration or reverse osmosis in which the conversion rates are higher than the conversion rates obtained with the current treatment processes.

To overcome this disadvantage, it has thus been proposed to pass these concentrates through a second nanofiltration membrane filtration unit or a second reverse osmosis unit.

This type of process enables the volume of residues removed into the natural environment to be reduced and consequently the amount of treated water produced to be increased, thereby helping to preserve the environment by preserving natural resources. In other words, this type of process helps to increase the conversion rate (denoted “Y”), which is defined by the following formula: Y=100−(Q_{residue}*100/Q_{supply}) (with Q_{residue} corresponding to the flow rate of discharged concentrate and Q_{supply} corresponding to the flow rate of water to be treated).

In addition, the problem of clogging of membranes occurs in numerous types of membrane treatment processes, in particular when the conversion rates are high. Indeed, over time, the pores of the membranes become closed off, thereby increasing the head losses and reducing the efficiency of treatment plants.

The clogging of membranes requires membrane cleaning operations to be performed regularly.

Over the long term, these cleaning phases can lead to deterioration of the membranes. Beyond a certain degree of deterioration, the membranes must be replaced.

To limit the frequency of cleaning operations and replacement of filtration membranes, it has been proposed, in the context of the treatment of water containing inorganic matter, to implement a physicochemical treatment between the two nanofiltration or reverse osmosis steps.

This type of physicochemical treatment essentially helps to prevent salt precipitation on the membranes.

However, when the water to be treated contains organic matter, the organic clogging of membranes can be fairly significant. It has also been observed that, in the context of treatment of such water containing organic matter, the development of a biofilm at the surface of the membranes could contribute to the clogging thereof.

It has not been proposed to insert, between two nanofiltration or reverse osmosis steps, a treatment suitable for treating water containing organic matter. However, in numerous cases, the water to be rendered potable, desalinated, recycled or purified for industrial use has non-negligible concentrations of organic matter.

The implementation of physicochemical treatments as proposed by the prior art techniques would not enable the organic clogging to be satisfactorily prevented in a second filtration step. Similarly, effective prevention of the development of such a biofilm would require, when possible, the use of chemical products in amounts that are economically or ecologically prohibitive.

In other words, there is a relatively pronounced need for nanofiltration or reverse osmosis water treatment processes with a high conversion rate, and which, during implementation, tend not to generate organic or biological clogging problems.

### OBJECTIVES OF THE INVENTION

The invention is intended in particular to overcome these disadvantages of the prior art.

More specifically, an objective of the invention is to provide, in at least one embodiment, a technique for treating water, containing organic matter, by nanofiltration or reverse osmosis for the potabilization thereof, purification for industrial use, recycling or desalination, which is more environmentally friendly.

In particular, an objective of the invention is to implement, in at least one embodiment, such a technique that has a high conversion rate, i.e. that enables the amount of concentrates discharged into the natural environment to be reduced, and the amount of treated water produced to be increased.

Another objective of the invention is to discharge a purified concentrate of pollutants initially present in the water collected.

Another objective of the invention is to provide, in at least one embodiment of the invention, such a technique that enables the amounts of chemical product necessary for treating the water in question to be reduced.

The invention is also intended to propose, in at least one embodiment, such a water treatment technique in which the frequency of maintenance servicing is relatively low, at least by comparison with the prior art techniques.

In particular, an objective of the invention is to implement, in at least one embodiment, such a water treatment technique that enables clogging to be reduced, in particular organic and/or biological clogging of the membranes used during implementation of the technique.

Another objective of the invention is to provide, in at least one embodiment, such a water treatment technique that enables the wear of the membranes to be limited and that consequently enables the frequency of replacement thereof to be reduced.

The invention is also intended to provide, in at least one embodiment, such a water treatment technique that is relatively effective and reliable, at least by comparison with the prior art techniques.

### DESCRIPTION OF THE INVENTION

These objectives, as well as others which will be described below, are achieved by a process for treating freshwater, seawater, brackish water or water leaving a wastewater treatment plant, containing organic matter of which the TOC content varies from 0.5 to 50 ppm, for the potabilization, desalination or recycling thereof or for the purification thereof for industrial use, in which said process includes at least:
a primary treatment step including a phase of grit removal-screening and/or oxidation and/or coagulation and/or flocculation and/or settling and/or membrane filtration of the microfiltration or ultrafiltration type, of said water;
a first step of filtration by nanofiltration or reverse osmosis of a flow coming from said first treatment step;
a second step of filtration by nanofiltration or reverse osmosis of a concentrate coming from said first filtration step;
a step of recovering a permeate from said first filtration step;
a step of discharging a treatment residue into the natural environment.

According to the invention, such a process includes an intermediate treatment step including a biological treatment and/or coagulation at low pH of said concentrate coming from said first filtration step and/or said concentrate coming from said second filtration step.

Advantageously, said intermediate treatment step (12, 12″) includes only one biological treatment.

Thus, the invention is based on an innovative approach enabling the treatment of water containing organic matter, whether it is fresh, brackish, leaving a wastewater treatment plant or saltwater, and which consists of subjecting the concentrate obtained in a first step of nanofiltration or reverse osmosis of the water to be treated to an intermediate biological treatment followed by a nanofiltration or reverse osmosis step.

This original approach, according to which the intermediate treatment undergone by the concentrate includes a biological treatment phase, enables organic as well as biological clogging of the filtration or reverse osmosis membranes to be prevented. Indeed, by providing a biological treatment upstream of the second nanofiltration or reverse osmosis step, the concentration of organic matter contained in the concentrate coming from said first filtration step can be reduced, and, consequently, the amount of organic matter deposited on the membranes can be reduced. In addition, the reduction of the concentration of organic matter in this concentrate enables the proliferation of biomass to be limited, and, consequently, the formation of a biofilm on the membranes of the second filtration step to be reduced.

This original approach also enables, due to the fact that the intermediate biological treatment leads to degradation of some of the organic matter originally present in the water to be treated, the concentration of organic matter in the residues to be reduced. It also enables a reduction in the amounts of chemical products that should be used so as to reduce the organic pollution by comparison with a process not implementing an intermediate biological treatment. All of this helps to reduce the volume of residues discharged into the natural environment and thus tends to satisfy increasingly strict environmental constraints.

The fact that the intermediate treatment step can include a step of coagulation at low pH is of interest when the concentration of biodegradable organic matter is low. Indeed, the coagulation at low pH enables the organic matter not biologically degradable by a physicochemically way to be precipitated, unlike the biological treatment. The choice between the biological treatment or coagulation at low pH can be made according to the type of water to be treated and the nature of the organic matter that it contains.

It is also possible to implement a biological treatment and coagulation at low pH so as to reduce the content of biologically and non-biologically degradable organic matter.

The process according to the invention advantageously enables a suitable treatment to be obtained when said water contains between 1 and 15 ppm of TOC (Total Organic Concentration).

According to an advantageous feature of the invention, the total conversion rate of said primary treatment step and said first filtration step is between 40% and 90% and the overall conversion rate of said first intermediate treatment step and said second filtration step is between 20% and 90%.

Preferably, the total conversion rate of said primary treatment step and said first filtration step is between 75% and 85% and the overall conversion rate of said first intermediate treatment step and said second filtration step is between 60% and 80%.

The implementation of a process according to the invention thus enables the amount of residue discharged into the environment to be limited, and a larger amount of treated water to be produced by comparison with the implementation of the prior art techniques.

According to an advantageous feature, a process according to the invention includes at least the implementation, in series, of a second intermediate treatment step then a third step of filtration of said concentrate coming from said second filtration step.

This increases by tenfold the capacities of the process according to the invention, and consequently increases the overall conversion rate thereof.

According to a preferred aspect of the invention, said second intermediate treatment step includes a biological treatment.

This makes it possible to help eliminate the biodegradable organic pollution and therefore to limit the clogging of the membranes in the subsequent filtration stages. This also helps to limit the formation of a biofilm on the membranes. The frequency of replacement of the membranes can therefore be reduced.

Advantageously, said second intermediate treatment step includes a physicochemical treatment.

In this case, this physicochemical treatment preferably belongs to the group including:
a biocide injection;
oxygen removal;
acidification;
salt precipitation;
decarbonation with soda or lime;
softening.

The implementation of such a physicochemical treatment can in particular enable precipitation on the membranes of salts contained in the concentrate to be reduced. This also helps to reduce the deterioration of the membranes.

It is also advantageously possible for said second intermediate treatment step to include a clarification treatment of the type of a settling tank and/or flotation and/or granular-bed filter and/or oxidation and/or microfiltration or ultrafiltration membrane.

Some of the matter in suspension in the water to be treated can thus be removed before it undergoes a third nanofiltration or reverse osmosis step, thereby again helping to prevent clogging of the membranes.

According to another advantageous aspect, a process according to the invention includes a step of treating said residue before discharging it into the natural environment, in which said treatment step consists of adsorption and/or oxidation and/or a biological treatment.

The implementation of such a concentrate treatment step enables an effluent purified of pesticides, of which the organic matter content complies with legislation, to be discharged into the natural environment.

According to another advantageous feature, a process according to the invention includes a step of recirculating, in said concentrate coming from said first filtration step, a flow coming from said first intermediate step of treatment of said concentrate coming from said second filtration step.

This implementation enables the efficacy of the intermediate treatment to be optimized. Indeed, a biological treatment will be more effective on the concentrated concentrate after the nanofiltration or reverse osmosis step because the biodegradable organic matter content thereof will be greater. Similarly, if this intermediate treatment includes a physicochemical treatment, the precipitation of salts will be faster if the concentration thereof is high.

According to another preferred aspect, a process according to the invention includes a step of mixing a permeate coming from said second filtration step with said permeate coming from said first filtration step.

The amount of treated water produced by the implementation of the process according to the invention is consequently greater than that produced by implementing a process according to the prior art.

A process according to the invention preferably includes a step of mixing a permeate coming from at least one of said third filtration steps with said permeate coming from said first filtration step.

Thus, when a process according to the invention includes one or more implementations, in series, of a second intermediate treatment step then a third filtration step performed on said concentrate coming from said second filtration step, this additional feature further increases the amount of treated water produced.

### LIST OF FIGURES

Other features and advantages of the invention will become clearer in view of the following description of preferred embodiments, provided as simple illustrative and non-limiting examples, and the appended drawings, in which:

FIG. 1 shows a diagram of a first embodiment of a process for treating water according to the invention;

FIG. 2 shows a specific implementation enabling the capacities of the water treatment process according to the first embodiment described in reference to FIG. 1 to be increased;

FIG. 3 shows a diagram of a second embodiment of a water treatment process according to the invention.

### DESCRIPTION OF EMBODIMENTS OF THE INVENTION

### Summary of the Principle of the Invention

The general principle of the invention is based on an original approach enabling the treatment of water containing organic matter, whether it is freshwater, brackish water, water leaving a wastewater treatment plant, or saltwater, and which consists of subjecting the concentrate resulting from a first step of nanofiltration or reverse osmosis of the water to be treated to a nanofiltration or reverse osmosis step preceded by an intermediate step enabling the organic matter to be removed, such as a biological treatment or coagulation at low pH.

The implementation of such an intermediate treatment step enables, in particular:
the concentration of organic matter contained in the concentrate coming from the first filtration step to be reduced, and
the proliferation of biomass in the concentrate to be limited,

before it is subjected to a nanofiltration or reverse osmosis step.

In other words, the implementation of such an intermediate treatment enables organic as well as biological clogging of the nanofiltration or reverse osmosis membranes to be prevented.

### Example of a First Embodiment of a Water Treatment Process According to the Invention

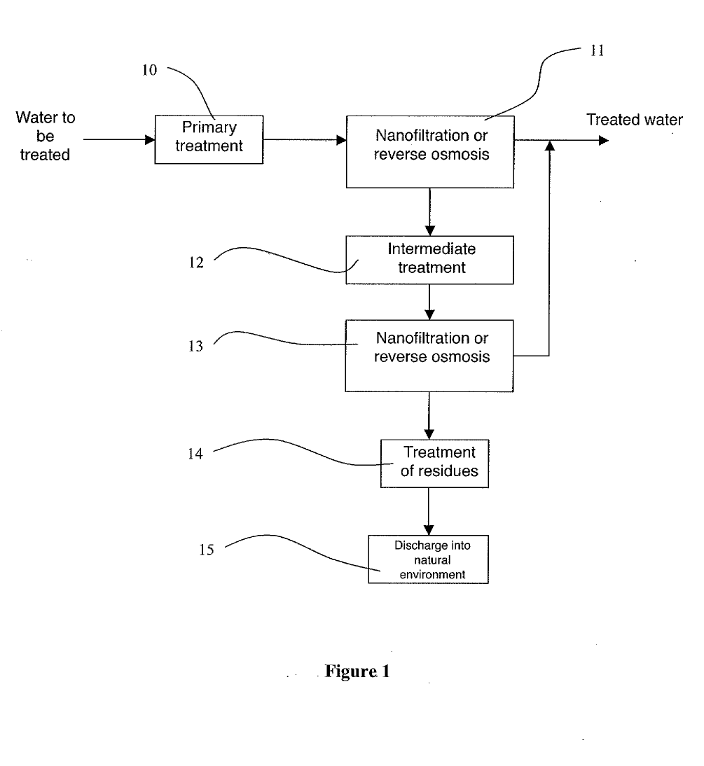

A water treatment process according to a first embodiment of the invention will be described in reference to FIG. 1.

As shown, this water treatment process, which can be implemented in the treatment of freshwater, brackish water, water leaving a wastewater treatment plant, or saltwater for the potabilization, purification, recycling or desalination thereof includes a step of primary treatment 10 of the water to be treated.

This primary treatment step 10 can in particular include a grit removal/screening phase to retain a significant part of relatively large-sized solid particles initially present in the water to be treated.

This primary treatment step 10 can also include a pre-oxidation step (O2, KmnO4, Chloramine, ClO2, Cl2, O3, etc.) to oxidize the reduced metals (iron, manganese, etc.) and improve coagulation.

This primary treatment step 10 can also include a coagulation phase so as to promote the flocculation of colloidal particles contained in the water to be treated.

This coagulation phase can classically be followed by a flocculation phase so that the colloidal particles in suspension in the water to be treated join together to form flocs.

The primary treatment 10 can also include a settling step during which the flocs previously formed separates from the water to be treated.

The primary treatment 10 can finally include a step of membrane filtration such as microfiltration or ultrafiltration.

The water having undergone this primary treatment is then subjected to a first nanofiltration or reverse osmosis step 11 according to the use for which it is intended.

The nanofiltration or reverse osmosis step 11 leads to the production of:
a permeate which constitutes, at least partially, the treated water produced, and
a concentrate which constitutes a filtration residue.

The concentrate resulting from this first filtration step 11 contains in particular organic matter, pesticides and salts.

This concentrate is then directed so as to undergo a second nanofiltration or reverse osmosis step 13.

It is noted that, in an entirely original manner, according to the invention, the concentrate is subjected to an intermediate treatment step 12 prior to the implementation of this second nanofiltration or reverse osmosis step 13.

This intermediate treatment step 12 includes in particular a biological treatment. This type of biological treatment can in particular consist of a treatment on fixed cultures such as a filtration on granular activated carbon, on an aerated sand filter, on a biofilter or on a membrane bioreactor or any other suitable biological treatment process. Such an intermediate treatment enables the organic matter concentration in the concentrate to be reduced. It thus makes it possible to prevent, or at the very least to limit, the organic clogging of the filtration or reverse osmosis membranes. It also enables, due to the low concentration of organic matter in this concentrate, the formation of a biofilm on the membranes to be prevented.

Thus, aside from the implementation of this intermediate biological treatment step 12, the frequency of cleaning and replacement of the membranes can be reduced on the second nanofiltration or reverse osmosis step. This helps to reduce the production costs incurred by the implementation of such a process.

In an alternative, the biological treatment can be replaced by coagulation at low pH. The coagulation at low pH enables physicochemical precipitation of the organic matter, unlike the biological treatment, which degrades the organic matter. This treatment can be applied alternatively to the biological treatment when the latter is ineffective, such as when little biodegradable organic matter is present.

Depending on the composition of water to be treated, it may be necessary for this intermediate treatment also to include a complementary physicochemical treatment.

Such a physicochemical treatment can in particular enable precipitation on the membranes of salts contained in the concentrate to be reduced, for example by injecting an acidifying agent. It can also consist of oxidation, salt precipitation, decarbonation with soda or lime, or softening.

In addition, the content of non-biologically biodegradable organic matter in the concentrate, and the organic clogging of membranes, can advantageously be reduced by injecting a biocide into the concentrate, or by subjecting it to oxygen removal, for example by injecting an oxygen reducer or by implementing a membrane contactor. Other suitable means may of course be implemented in order to produce such effects.

The second nanofiltration or reverse osmosis step 13 enables a permeate and a concentrate to be produced. The permeate thus produced is collected and mixed with the permeate produced during the first nanofiltration or reverse osmosis step 11, thereby increasing the amount of treated water produced, and is more environmentally friendly.

The conversion rate obtained by the implementation of the primary treatment step 10 and the first nanofiltration or reverse osmosis step varies between 40 and 90%, and is more generally on the order of 85%, which means that it leads to the discharge of 15% concentrate, in general.

The conversion rate obtained by the implementation of the intermediate treatment step 12 and the second nanofiltration or reverse osmosis step 13 is between 20 and 90% and more generally between 60 and 80%.

The overall conversion rate obtained by the implementation of all of these steps 10, 11, 12 and 13 is therefore between 52 and 99.99%, and more generally between 94 and 97%.

The implementation of these process steps according to the invention can therefore generally lead to the production of 3% to 6% residue, whereas the prior art techniques commonly generate between 15 and 25% residue.

The concentrate produced during the second nanofiltration or reverse osmosis step 13 is then directed so as to undergo a treatment step 14 before it is discharged 15 into the natural environment.

This treatment step 14 can in particular include adsorption, for example on granular activated carbon (GAC) or on powdered activated carbon (PAC) and/or oxidation, for example with ozone, and/or a biological treatment. It may also include evaporation or coagulation, flocculation or sedimentation.

The implementation of such a concentrate treatment step 14 enables an effluent purified of pesticides, and of which the organic matter content complies with legislation, to be discharged into the natural environment.

The implementation of a treatment process according to this first embodiment enables an overall conversion rate of between 94% and 97% to be obtained, and thus the volume of residue to be reduced, and the volume of water produced to be increased. This consequently enables a reduction in the size of the plants necessary for treating concentrates, before they are discharged into the natural environment. It also helps to limit the clogging of membranes and to reduce the frequency of maintenance servicing.

### Increased Capacity of a Water Treatment Process According to the First Embodiment of the Invention

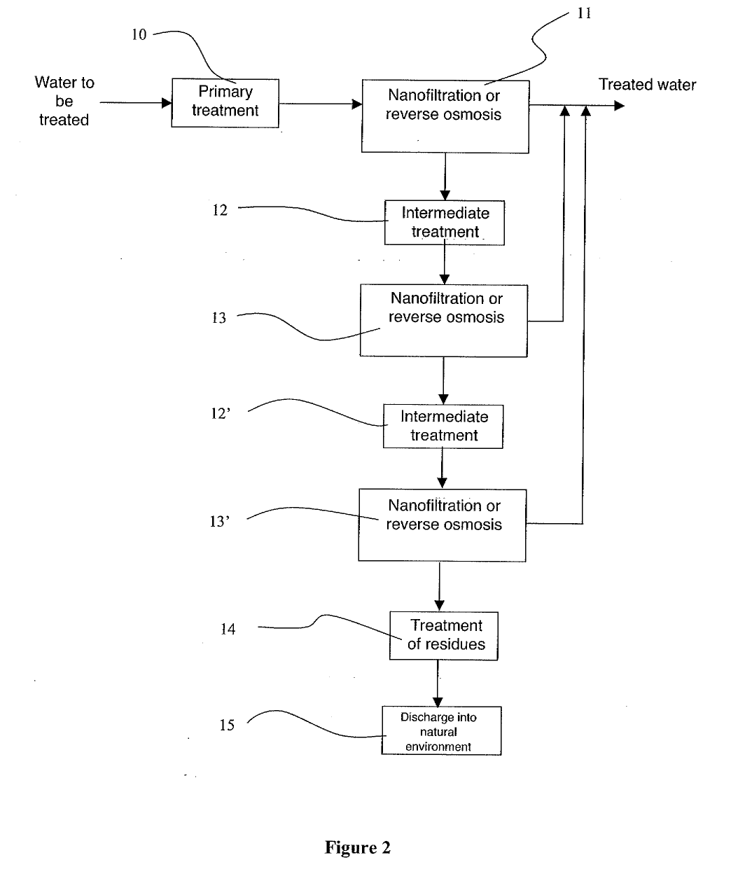

An example of an implementation that can enable the capacities of a water treatment process according to the first embodiment of the invention to be increased will be described in reference to FIG. 2.

In said FIG. 2, reference signs identical to those appearing in FIG. 1 are used to designate equivalent steps implemented in the process according to the first embodiment.

Only the essential differences between this implementation example and the first embodiment described above will be mentioned.

This implementation example consists of increasing the capacities of the process according to the first embodiment by providing the implementation in series of a second intermediate treatment step 12′, then a third step 13′ of filtration by nanofiltration or reverse osmosis of the concentrate coming from said second nanofiltration or reverse osmosis step 13.

The intermediate treatment 12′ and nanofiltration or reverse osmosis 13′ treatment steps can be similar to the intermediate treatment 12 and nanofiltration or reverse osmosis 13 treatment steps.

According to other alternatives, the capacity of the process according to the first embodiment can be increased by providing a plurality of implementations in series of a second intermediate treatment step 12′ then a third step 13′ of filtration by nanofiltration or reverse osmosis of the concentrate coming from said second nanofiltration or reverse osmosis step 13.

For example, providing two implementations in series of a second treatment step 12′ then a third step 13′ of filtration by nanofiltration or reverse osmosis of a concentrate coming from said second nanofiltration or reverse osmosis step 13 would consist, in reference to FIG. 2, of implementing a third intermediate treatment step followed by a fourth nanofiltration or reverse osmosis step between steps 13′ and 14.

Such implementations can enable the conversion rate of the process to be further increased. It is thus possible to implement water treatment processes of which the conversion rate may be up to 99.9%.

### Example of a Second Embodiment of a Water Treatment Process According to the Invention

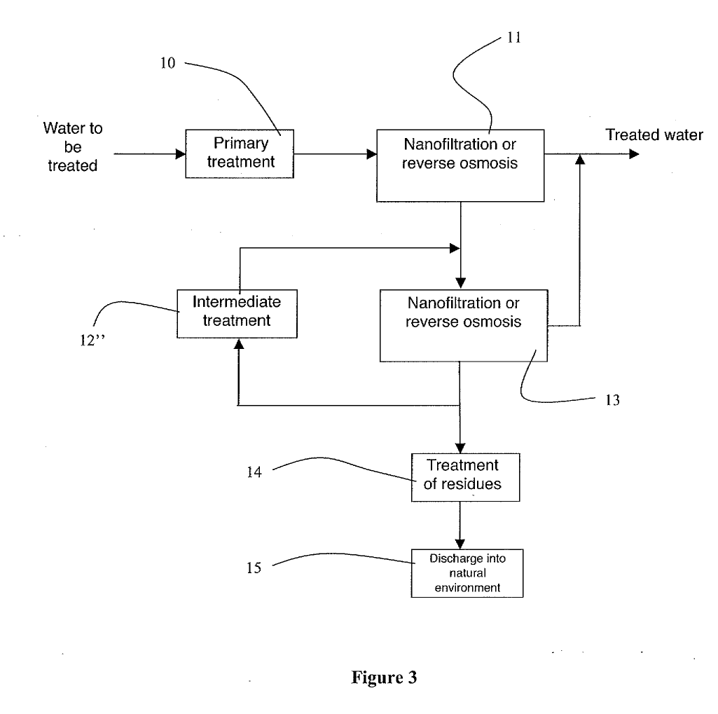

A water treatment process according to a second embodiment of the invention will be described in reference to FIG. 3.

In this FIG. 3, reference signs identical to those used in FIGS. 1 and 2 are used to designate equivalent steps implemented in the process according to the first embodiment.

Only the essential differences between this second embodiment and the first embodiment above will be described.

As shown, the essential difference that exists between this second embodiment and the first embodiment lies in the fact that the concentrate resulting from the first nanofiltration or reverse osmosis step 11 is directed directly so that it undergoes a second nanofiltration or reverse osmosis step 14 without undergoing any intermediate treatment.

However, the concentrate coming from this second nanofiltration or reverse osmosis step 13 is at least partly directed so that it undergoes an intermediate treatment step 12″, which includes in particular a biological treatment. Of course, this treatment step 12″ can include other types of treatments, in the same manner as the intermediate treatment step 12 of the first embodiment.

In an alternative, the intermediate treatment may consist of coagulation at low pH.

In this embodiment, at least some of the concentrate having undergone this intermediate treatment step 12″ is recirculated so that it is mixed with the concentrate newly produced during the implementation of the first nanofiltration or reverse osmosis step 11.

This implementation enables the efficacy of the treatment 12″ to be optimized. A biological treatment will indeed be more effective on the concentrated concentrate after the nanofiltration step 13 because the biodegradable organic matter content thereof will be greater. Similarly, if the treatment 12″ includes a physicochemical treatment, the precipitation of salts will be faster if the concentration thereof is high.

### Tests

### Without the Implementation of an Intermediate Biological Treatment

Tests have been conducted in order to concentrate the concentrates with a treatment process according to the first embodiment, in which the intermediate biological treatment step has not been implemented. The membranes used during these tests were flat nanofiltration membranes.

Such a process enabled a conversion rate on the order of 75% to be obtained on the nanofiltration step, which gave an overall conversion rate of 96%. However, the performance of such tests over a longer period and on an industrial scale led to organo-mineral and biological clogging of the membranes.

### Implementation of an Intermediate Biological Treatment

To attest to the efficacy of an intermediate biological treatment, tests consisting of treating membrane concentrates on two GAC (granular activated carbon) columns positioned in series were conducted.

The process conditions were as follows:
contact time: 2 times 20 min;
supply flow rate: 0.2 l/h.

The reduction in COD (chemical oxygen demand) obtained after 1 month of 24 h/24 operation on GAC (granular activated carbon) was as follows:
15% to 20% reduction after 20 minutes of contact time;
25% to 30% of reduction after 40 minutes of contact time.

In conclusion, a biological treatment on a GAC (granular activated carbon) filter enables 30% of the COD (chemical oxygen demand) to be eliminated, i.e. the entire biodegradable part of the organic matter.

1-12. (canceled)

13. A method of treating water containing organic matter comprising:
a. subjecting the water to primary treatment and producing a primary effluent;
b. directing the primary effluent to a first nanofiltration unit or a first reverse osmosis unit and filtering the water in the first nanofiltration unit or the first reverse osmosis unit to produce a first permeate stream and a first concentrate stream;
c. discharging the first permeate stream to a natural environment;
d. directing the first concentrate stream to an intermediate treatment unit and biologically treating the first concentrate stream to remove organic matter therefrom or precipitating organic matter from the first concentrated stream so as to produce a treated concentrate stream; and
e. directing the treated concentrate stream to a second nanofiltration unit or a second reverse osmosis unit and filtering the treated concentrate stream and producing a second permeate stream and a second concentrate stream.

14. The method of claim 13 including directing the second concentrate stream to a third nanofiltration unit or a third reverse osmosis unit and filtering the second concentrate stream to produce a third permeate stream and a third concentrate stream.

15. The method of claim 13 including mixing the first and second permeate streams and discharging the mixture of the first and second permeate streams to the natural environment.

16. The method of claim 14 including mixing the first, second and third permeate streams and discharging the mixture of the first, second and third permeate streams to the natural environment.

17. The method of claim 13 wherein the step of directing the first concentrate stream to the intermediate treatment unit includes biologically treating the first concentrate stream to remove organic matter therefrom.

18. The method of claim 13 wherein directing the first concentrate stream through the intermediate treatment unit includes subjecting the first concentrate stream to physiochemical treatment and causing organic matter to be precipitated from the first concentrate stream.

19. The method of claim 18 wherein the physiochemical treatment includes a biocide injection, oxygen removal, acidification, salt precipitation, decarbonation with soda or lime, or softening.

20. The method of claim 13 wherein the intermediate treatment unit includes a clarifier.

21. The method of claim 14 wherein the method produces a conversion rate of at least 94% thereby producing a residue of 6% or less.

22. The method of claim 13 including directing the second concentrate stream to a treatment unit for treating the second concentrate stream wherein the second treatment unit includes an activated carbon treatment process, an oxidation process or a biological treatment process.

23. A method of treating water containing organic matter comprising:
a. subjecting the water to preliminary treatment and producing a primary effluent;
b. directing the primary effluent to a first nanofiltration unit or first reverse osmosis unit and filtering the water in the first nanofiltration unit or first reverse osmosis unit and producing a first permeate string and a first concentrate stream;
c. directing the first concentrate string to a second nanofiltration unit or a second reverse osmosis unit and filtering the water in the second nanofiltration unit or the first reverse osmosis unit to produce a second permeate string and a second concentrate stream;
d. directing at least a portion of the second concentrate stream to an intermediate treatment unit and biologically treating the second concentrated stream to remove organic matter therefrom or precipitating organic matter from the second concentrate stream so as to produce a treated concentrate stream;
e. directing the treated concentrate stream to one of the first or second nanofiltration units or to one of the first or second reverse osmosis units for further filtering.

24. The method of claim 23 including directing at least a portion of the second concentrate stream to a downstream treatment unit for treating the second concentrate stream.

25. The method of claim 24 wherein the downstream treatment unit for treating at least a portion of the second concentrate stream includes a process for utilizing activated carbon for treating the second concentrate stream, a process for oxidizing the second concentrate stream, or a biological treatment process for treating the second concentrate stream.

26. The method of claim 23 including mixing the first and second permeate streams and discharging the mixture of the first and second permeate streams to a natural environment.

27. The method of claim 23 including directing a portion of the treated concentrate stream from the intermediate treatment unit and mixing a portion of the treated concentrate stream with the first concentrate stream at a point upstream from the second nanofiltration unit or second reverse osmosis unit.

28. The method of claim 23 wherein the overall conversion rate for the method is 94% or above.

29. The method of claim 23 wherein the process produces a residue of 3% to 6%.
